(19) United States
(12) Patent Application Publication
(10) Pub. No.: US 2022/0009279 A1
(43) Pub. Date: Jan. 13, 2022

(54) Mud-Plastering Scoop

(71) Applicants: Francisco J. Juarez, Petaluma, CA (US); Ivan Juarez, Petaluma, CA (US)

(72) Inventors: Francisco J. Juarez, Petaluma, CA (US); Ivan Juarez, Petaluma, CA (US)

(21) Appl. No.: 16/927,024

(22) Filed: Jul. 13, 2020

(51) Int. Cl. B44D 3/16

(52) U.S. Cl. CPC B44D 3/162

(57) ABSTRACT

A scoop for removing semi-fluid materials such as acrylic stucco from a bucket, with a close gripping handle to improve leverage and a scalloped top edge of the receptacle that allows excess material to flow out of the receptacle.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### 1. Field of the Invention

The present invention relates generally to a scoop for removing semi-fluid material from a bucket. More specifically, the present invention relates to a scoop capable of removing material such as acrylic stucco from a bucket.

### 2. Description of the Related Art

Semi-fluid materials such as stuccos, plasters and joint compounds are generally provided at the commercial level in five gallon buckets. A conventional trowel is frequently used to remove joint compound from a five gallon drum. This is satisfactory only until the container becomes about one-third fill. At that time, it becomes more difficult to remove the remaining compound from the bucket. Scoops such as those disclosed in U.S. Pat. No. 5,799,997 and Design Patent #391,131 with rounded edges that match the side wall arc of the container have been developed that help to scoop the remaining material out of the bucket.

When used with more fluid materials, these scoops can be difficult to use because they have very high sides in the receptacle and handle grips that are too far from the receptacle. The high sides on the receptacle result in scooping up too much material so the scoop becomes excessively heavy with semi-fluid material and therefore difficult to handle. Because the handle grips are not close to the receptacle, the user does not have good leverage when scooping the material. Another disadvantage of the existing designs is that the user must use a plaster hawk to transfer the material to a trowel for application. The present invention addresses all of these issues by providing a shorter distance to the grasped area of the handle and a scalloped edge on the sides of the receptacle. The scalloped edge allows excess material to flow out of the receptacle, reducing the load and making the tool easier to manipulate. In addition, the width of the disclosed invention allows the user to apply the material directly to the trowel without needing a plastering hawk.

### BRIEF SUMMARY OF THE INVENTION

The present invention is a mud-plastering scoop comprised of a handle that is attached to a receptacle with a flat bottom and rounded sides that extend on either side of the handle to approximately half way around the flat bottom. The flat bottom is oval shaped at the handle side, with the handle attached on the long edge of the oval and semi-circular on the opposite side. The semi-circular edge is designed to match the inner radius of a bucket to facilitate scooping material from the bucket. The rounded sides extend approximately one third up the sides of the handle and taper down to the flat bottom along the oval shaped side in three steps such that the top edge of each side has a scalloped cut and the area at the bottom of the scoop is maximized. The scalloped cut facilitates movement of semi-liquid material out of the scoop when scooping material from the bucket such that the amount of excess liquid material is reduced, making scooping easier.

### BRIEF DESCRIPTION OF THE SEVERAL VIEWS OF THE DRAWINGS

A more complete understanding of the present invention may be derived by referring to the detailed description and claims when considered in connection with the figures, wherein like reference numbers refer to similar items throughout the figures and:

FIG. 1 is a perspective view of the mud-plastering scoop;

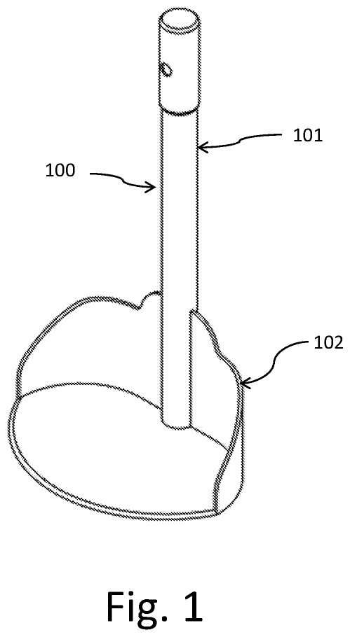

FIG. 2 is a front view of the mud-plastering scoop;

FIG. 3 is a side view of the mud-plastering scoop; and

FIG. 4 is a top view of the mud-plastering scoop;

### DETAILED DESCRIPTION OF THE INVENTION

In the following detailed description of the invention, reference is made to the accompanying drawings which form a part of the disclosure and, which show by way of illustration, and not of limitation, specific embodiments by which the invention may be practiced. The drawings, the foregoing discussion, and the following description are exemplary and explanatory only, and are not intended to limit the scope of the invention or its application in any manner.

The present invention is a Scoop 100 with a Handle 101 and a Receptacle 102. The Scoop 100 may be made from any number of independent pieces that are firmly attached together or from a single piece of material. The material used may be any suitable material such as metal, wood or stiff plastic, or any combination of materials. In a preferred embodiment, the Scoop 100 is made from a single piece of high density polyethylene (HDEP) for ease of manufacture and optimum stiffness.

The Handle 101 is a cylindrical rod with a diameter and length that is sized for easy grasping and preferably has a Hanging Device 201 attached at its top with a Hole 202 that extends horizontally through its center. In a preferred embodiment, the Handle 101 diameter is approximately 1 inch, and the overall length from the top of the Receptacle 102 to the bottom of the Hanging Device 201 is approximately 7 inches. This limited length aids in scooping by allowing the user to grasp the tool close to the Receptacle 102 to improve leverage. The Hole 202 is sized such that the Scoop 100 may be hung on a hook in a tool shop for ease of storage and to facilitate drying of the Scoop 100 after cleaning.

The Receptacle 102 consists of a Flat Bottom 203 and two Sides 204 that are firmly attached to the Handle 101. The volume of the Receptacle 102 may vary depending on the weight of the specific material that will be scooped using this tool, but in a preferred embodiment for a semi-fluid material such as acrylic stucco, the volume should be approximately 120 cubic inches. The material used for the Flat Bottom 203 and the two Sides 204 should be just thick enough to provide a stiff, non-pliant structure that will not deform under the weight of the semi-fluid material when the scoop is filled with it. In a preferred embodiment, where the material is HDEP, the preferred thickness is approximately 0.10 inches.

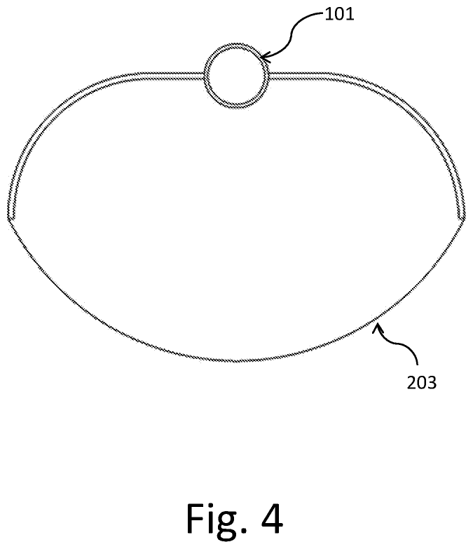

As shown in FIG. 4, the shape of the side of the Flat Bottom 203 that is attached to the Handle 101 is one half of an oval wherein the Handle 101 is attached in the middle of the long edge of the oval. In a preferred embodiment for use with a standard five gallon bucket, the long dimension of the half oval is approximately 8 inches. This dimension would be appropriately adjusted for use of the tool with other sized buckets. The opposite side of the Flat Bottom 203 is a semi-circular shape with a radius that matches the interior of the bucket; for a five gallon bucket the preferred radius is approximately 4.5 inches. The preferred size for the overall depth of the Flat Bottom 203 when designed for use with a five gallon bucket is approximately 5 inches.

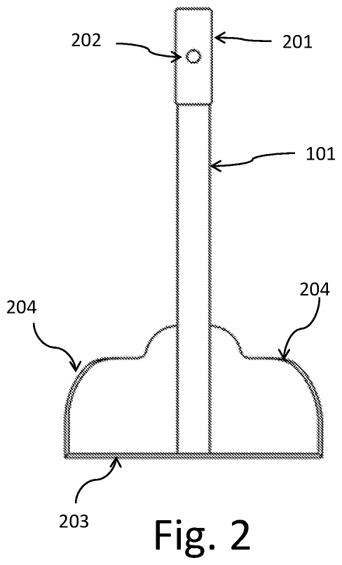

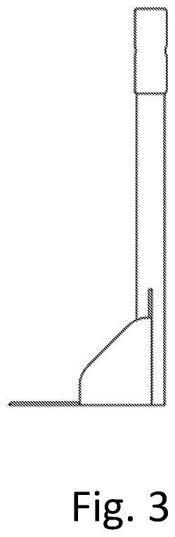

As shown in FIGS. 2, 3 and 4, the Sides 204 of the Receptacle 102 extend vertically from the Flat Bottom 203 and are curved to match the oval portion of the Flat Bottom 203. The shape of the Sides 204 is three-tiered, wherein from the attachment point at the handle, there is a radiused section which drops to an angled section and then a vertical section that drops to the Flat Bottom 203. In a preferred embodiment, each transition between sections is radiused to create a smooth edge. This creates a scalloped effect as shown in FIG. 2. In a preferred embodiment for use with a five gallon bucket, the top of each Side 204 connects to the Handle 101 at approximately 4 inches from the Flat Bottom 203, the top radiused section has a radius of approximately 1 inch, and the angled section is at approximately a 45 degree angle. These dimensions create a scoop volume in the Receptacle 102 of approximately 120 cubic inches which is ideal for acrylic stucco. The exact dimensions may be modified to adjust the volume for other plasters or compounds with different densities or fluid content.

Many modifications and variations of this invention may be made without departing from its spirit and scope, as will be appreciated by those skilled in the art. For example, the entire size of the tool can be adjusted for use in a smaller or larger bucket, the handle may be grooved for better gripping, and the material it is manufactured from can be stainless steel or other suitable materials. If the material is strong enough, the handle could be attached at the top of one solid side wall instead at the base of the tool. The specific embodiments described herein are offered by way of example only. The embodiments were chosen and described in order to best explain the principles of the invention and its practiced applications.

What is claimed is:

1. A scoop for removing semi-fluid material such as acrylic stucco from a bucket having a cylindrical sidewall with a radius of curvature comprising:
a base plate with a top, an oval shaped edge and a peripheral edge, the peripheral edge having a radius of curvature substantially the same as the radius of curvature of the cylindrical sidewall of the bucket;
a handle attached to the top of the base plate at the center of the oval shaped edge;
two side walls attached to the oval shaped edge of the base plate and the handle creating an open receptacle capable of holding semi-fluid material; each side wall having a shoulder section, an angled section and a vertical section wherein the shoulder section is adjacent to the handle and has a radiused top edge, the angled section has a top edge that extends horizontally and then slants downward from the shoulder section creating a scalloped shape, and the vertical section has a top edge that extends from the angled section to the base plate; and wherein the handle extends a sufficient distance above the side walls to be grasped by a user.
